(19) United States
(12) Patent Application Publication
(10) Pub. No.: US 2013/0339247 A1
(43) Pub. Date: Dec. 19, 2013

(54) ISSUER IDENTIFICATION AND VERIFICATION SYSTEM

(71) Applicant: VISA INTERNATIONAL SERVICE ASSOCIATION, San Francisco, CA (US)

(72) Inventors: Jer-Wei Lam, Singapore (SG); Siew Nee Yeo, Singapore (SG)

(21) Appl. No.: 13/920,420

(22) Filed: Jun. 18, 2013

Related U.S. Application Data
(60) Provisional application No. 61/661,057, filed on Jun. 18, 2012.

(51) Int. Cl. G06Q 20/40

(52) U.S. Cl. CPC G06Q 20/4016
USPC 705/44

(57) ABSTRACT

Embodiments of the present invention are directed to methods, systems, and apparatuses for identifying fraudulent portable devices and limiting fraudulent transactions. One embodiment of the invention is directed to a method. The method includes receiving, by a verification device, transaction data including an issuer identifier. The verification device further determines issuer information associated with the issuer identifier and provides the issuer information to a verifying entity. The verifying entity verifies that a portable device matches the issuer information before a transaction is authorized.

### CROSS-REFERENCES TO RELATED CASES

The present application is a non-provisional application of and claims priority to U.S. Provisional Application No. 61/661,057, filed on Jun. 18, 2012, the entire contents of which are herein incorporated by reference for all purposes.

### BACKGROUND

Counterfeit cards are a major source of fraudulent loss around the world. Many counterfeit cards use encoded payment information from foreign countries or regions from where the transaction is taking place. However, the cards may have card bodies (e.g., plastic card, metal card, etc.) that make the card appear to be a local card associated with a local account. Furthermore, in some cases, counterfeit cards may be produced with embossed numbers on the card body that match the encoded BIN and account data. However, the encoded BIN and account data point to a different account at a different bank then identified on the card body. Accordingly, the cards appear to be legitimate but are in fact counterfeit. The account associated with the account number on the magnetic stripe may be located in another country and may have been compromised. Traditionally, merchants have had no way of easily determining whether cards that are presented to them are counterfeit or not.

Embodiments of the present invention solve these problems and other problems individually and collectively.

### SUMMARY

Embodiments of the present invention are directed to methods, systems, and apparatuses for identifying fraudulent portable devices and limiting fraudulent transactions.

One embodiment of the invention is directed to a method comprising receiving, by a verification device, transaction data including an issuer identifier, determining, by the verification device, issuer information associated with the issuer identifier, and providing, by the verification device, the issuer information to a verifying entity, wherein the verifying entity verifies that a portable device matches the issuer information before a transaction is authorized.

Another embodiment of the invention is directed to a verification device. The verification device comprising a processor and a computer-readable medium coupled to the processor, the computer-readable medium comprising code executable by the processor for performing a method. The method comprising receiving transaction data including an issuer identifier, determining issuer information associated with the issuer identifier, and providing the issuer information to a verifying entity, wherein the verifying entity verifies that a portable device matches the issuer information before a transaction is authorized.

These and other embodiments of the invention are described in detail below.

### BRIEF DESCRIPTION OF THE DRAWINGS

FIG. 1 illustrates a block diagram of an exemplary issuer identification and verification system for offline issuer identification and verification of transactions, according to an exemplary embodiment of the present invention.

FIG. 2 illustrates an exemplary flow chart of a method for offline identification and verification of a portable device, according to an exemplary embodiment of the present invention.

FIG. 3 illustrates a block diagram of an exemplary issuer identification and verification system for online issuer identification and verification of transactions, according to an exemplary embodiment of the present invention.

FIG. 4 illustrates an exemplary flow chart of a method for online identification and verification of a portable device, according to an exemplary embodiment of the present invention.

FIG. 5 illustrates exemplary counterfeit cards that the present invention is designed to identify.

FIG. 6 illustrates an exemplary verification step by a merchant representative, according to an exemplary embodiment of the present invention.

FIG. 7 illustrates a block diagram of an exemplary computer apparatus.

### DETAILED DESCRIPTION

Embodiments of the invention are directed to methods, systems, and apparatuses for verifying the authenticity of portable devices used during transactions. Embodiments allow merchants to actively screen for counterfeit portable devices (e.g., credit cards, debit cards, registered mobile devices, etc.) that appear to be issued by one issuer, but contain stolen account information from a second issuer encoded on the portable device. The portable devices may appear to be issued by a local issuer in order to lower suspicion by the merchant that the card is counterfeit or fraudulent. Such portable devices are almost impossible for merchants to identify as fraudulent because merchants are not provided the issuer information based on the encoded data. The only issuer information provided to the merchant is on the body of the portable device.

For example, most counterfeit credit cards have payment data encoded from issuers located in the United States of America and Europe that have been hacked by fraudsters. However, to avoid suspicion, a local fraud perpetrator may attempt to use a counterfeit card with a local bank card face (e.g., “Bank of Vietnam”) for the area that the fraudster wishes to use the counterfeit card (e.g., Vietnam). For this reason, the name of the issuer printed on the card face may not match the encoded issuer identifier (e.g., bank identification number (BIN)) on the counterfeit card. Further, fraudsters may configure the card so that the data thereon matches information associated with a fraudulent presenter. For example, the fraudulent card may include the name of the fraudulent presenter as well as a picture of the fraudulent presenter. Accordingly, it can be very difficult, if not impossible, for a merchant to determine that this type of card is counterfeit.

However, embodiments of the present invention use unique issuer identifiers to determine the issuer associated with account information encoded on a portable device and to provide issuer information including issuer name, country of origin, issuer trademark or other graphic, as well as any other relevant information to a merchant representative or other verifying party for verification at the initiation (or during processing) of a transaction. Accordingly, a verifying entity (e.g., a merchant representative) may have information about the encoded account information in order to ensure that the encoded account information matches the presented portable device.

For example, a consumer in the United States may attempt to purchase goods at a merchant using a credit card with a local issuer listed on the face of the credit card. During check out, the consumer may swipe their credit card at a merchant point-of-sale (POS) device that a merchant clerk or sales representative is monitoring. An issuer identification and verification system may determine an issuer identifier (e.g., bank identification number (BIN)) encoded on the credit card and may search a local issuer directory for issuer information associated with the issuer identifier (e.g., BIN). The issuer information may include, for example, the issuer's name and country of origin. The issuer information (e.g., issuer name and country of origin) may then be displayed to the merchant representative. The merchant representative may then compare the issuer information (e.g., issuer name and country) displayed at the merchant computer to the issuer information printed on the credit card in order to immediately determine whether the credit card being presented is counterfeit.

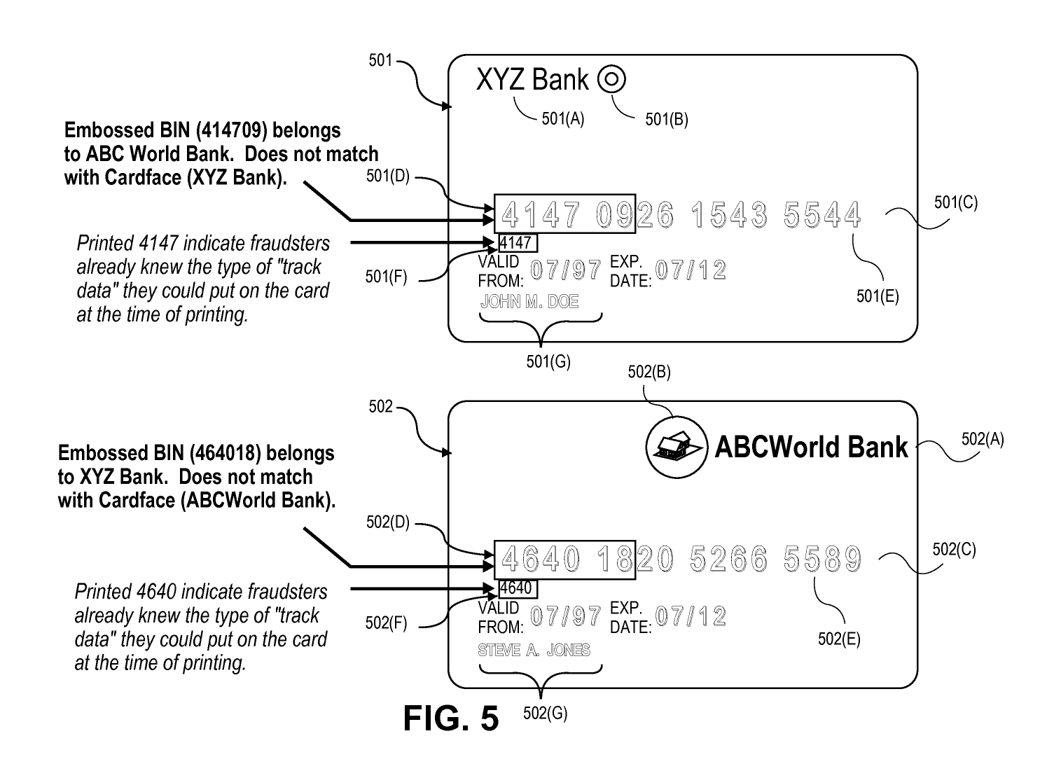

An example is provided in FIG. 5 which illustrates exemplary counterfeit cards that the present invention is designed to identify. As shown in the top card 501 of FIG. 5, the card face displays the supposed issuer's name 501(A) (e.g., XYZ Bank), shows the issuer's graphic 501(B) (e.g., XYZ Bank's trademark target graphic), embossed card digits of the account information supposedly encoded on the card 501(C) including an issuer identifier 501(D) (e.g., 414709) and account identifier 501(E) (e.g., 2615435544), as well as supplementary information 501(G) about the account (e.g., when the account was issued, when the account expires, cardholder's name, etc.). However, the encoded issuer identifier in the memory (not shown) of the card 501 actually belongs to the issuer “ABCWorld Bank” and account information “4147092615435544” actually identifies an account issued by the issuer “ABCWorld Bank.” Furthermore, as can be seen from the printed first four digits 501(F) 4147 of the issuer identifier located below the embossed issuer identifier 501(D) of 414709, the fraudsters may match the track data (issuer identifier 501(D) and account identifier 501(C)) encoded on the card to the embossed numbers displayed on the card body. Additionally, the fraudsters can also match the personal information (e.g., cardholder name, cardholder picture, etc.) on the card to any person they wish including the fraudulent presenter of the card. As such, merchant representatives have no way in which to determine whether they are accepting counterfeit cards for a transaction because the personal information shown on the card body may match the presenter of the card, even though the presenter is fraudulent.

However, using embodiments of the present invention, a merchant representative may be provided with the issuer information associated with the encoded account information including, for example, the issuer name (e.g., “ABCWorld Bank”), the issuer country or region of origin (e.g., “England”), an issuer trademark (e.g., the graphic of the house shown on card 502 or the target shown on card 501), or any other issuer information that may allow a merchant representative to quickly and easily determine that the presented card encoded account information does not match the presented card body.

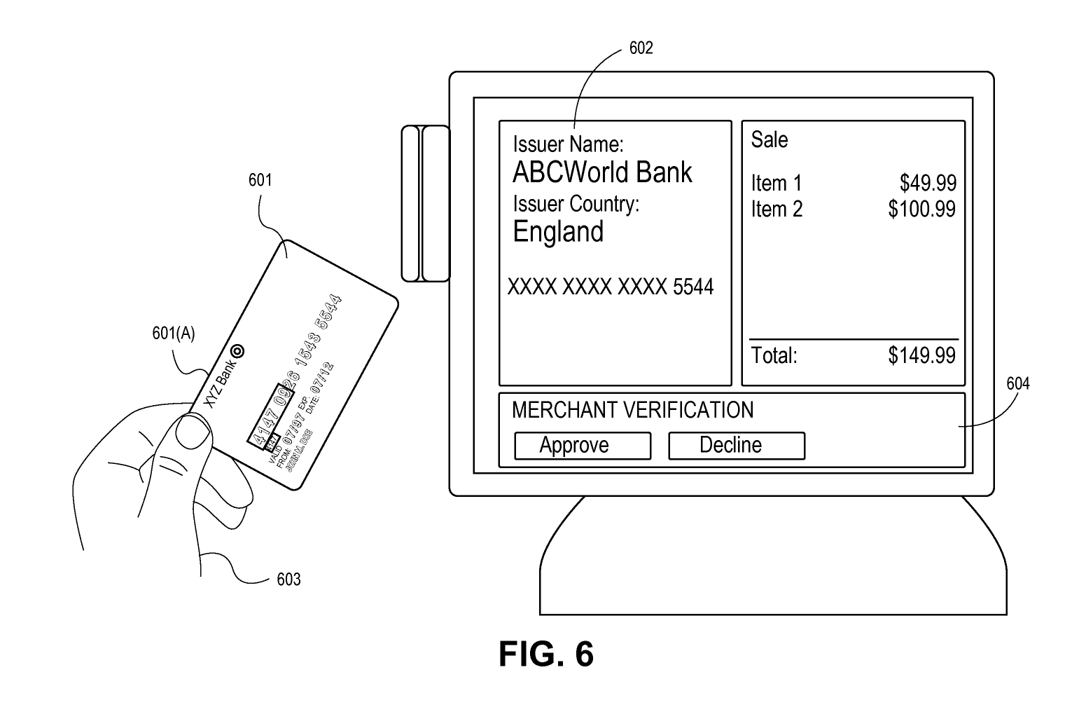

For example, FIG. 6 illustrates an exemplary verification step by a merchant representative, according to an exemplary embodiment of the invention. It may be well known that ABCWorld Bank is an issuer located in England and that XYZ Bank is an issuer located in the United States. Accordingly, if during a transaction where a consumer presents a card 601 with the body stating it is issued by XYZ Bank 601(A) but issuer information encoded on the card and displayed 602 to the merchant representative using embodiments of the present invention state that the encoded account is associated with issuer ABCWorld Bank from England, a merchant representative 603 may immediately know they should investigate further to determine if the card is a counterfeit.

Similarly, returning to FIG. 5, the bottom card 502 provides another example of a counterfeit card that may have encoded account information matching the numbers 502(C) on the embossed card body but the issuer associated with the encoded account information may be incorrect. As such, the issuer information that would be returned using embodiments of the present invention may notify the merchant representative accepting this card that the issuer name 502(A) displayed on the card face (e.g., “ABCWorld Bank”) does not match the issuer name associated with the encoded account information and thus, the card may be counterfeit and should be investigated further. If the personal information 502(G) shown on the front of the counterfeit card 502 matched the personal information of the fraudulent presenter of the card 502, without using embodiments of the present invention, the merchant representative would have no means of determining whether the card was counterfeit or not.

Although the cards shown in FIG. 5 relate to magnetic stripe transactions, fraudsters may utilize the same counterfeiting techniques to generate fraudulent cards using chip card transactions and any other transaction types. Accordingly, embodiments of the present invention could also be implemented in any type of transaction including short range communications transactions using near-field communication (NFC), transactions implementing chip cards, mobile transactions, etc.

Accordingly, embodiments of the invention allow merchants to identify the issuer of the account information encoded on a portable device and may compare that information provided on the face of the presented portable device to ensure counterfeit or fraudulent account information is not being used for the transaction. In addition to an issuer's name and issuer country, any other issuer related information may be provided to the merchant at the time of the transaction. For example, an issuer's home language, trademark, portable device design, and any other information may be used to determine if the presented portable device is using fraudulent account information.

Accordingly, embodiments of the present invention provide merchants a tool against counterfeit cards that look legitimate but use fraudulent payment data stolen from issuers. Furthermore, embodiments of the present invention provide a number of technical advantages. For example, embodiments of the present invention reduce fraudulent transactions before transaction processing is initiated by providing a verifying entity (e.g., merchant representative, ATM device, etc.) with the ability to stop or suspend a transaction until further identification or information is obtained. Stopping fraudulent transactions before authorization request messages are generated saves system resources related to transaction processing as well as account restoration, fraudulent charge-back, and other costs of system, monetary, and efficiency costs of fraudulent transactions.

Additionally, embodiments of the present invention use issuer information to determine whether a presented portable device is fraudulent or otherwise counterfeit. Accordingly, an analysis of account data is avoided. Therefore, large databases of account information are not required to determine whether a presented portable article is counterfeit. Instead, a smaller database of issuer information is sufficient to identify counterfeit portable devices. Accordingly, fewer system resources are necessary than systems that interrogate a consumer's account or issuer database for such information. Furthermore, embodiments of the invention allow for a distributed offline issuer directory that may be stored at access devices to ensure quick and efficient searching and the rapid return of issuer identifiers and associated issuer information. Accordingly, embodiments provide for fast, simple, and efficient issuer information look up and processing.

Prior to discussing the specific embodiments of the invention, a further description of some terms can be provided for a better understanding of embodiments of the invention.

According to some embodiments, “transaction data” can include any data associated with one or more transactions. In some embodiments, the transaction data may include encoded data from a portable device (e.g., credit card, debit card, mobile device operating a mobile wallet, chip card, etc.) that may be used to initiate a transaction. For example, transaction data may include Track 1 and/or Track 2 data that may be encoded on typical credit and debit cards. However, transaction data may further comprise information from a merchant or seller such as product codes, merchant name, merchant location, transaction amount, etc. Furthermore, transaction data may further comprise consumer information that is provided by a mobile wallet, account, or any other information that may be used to process a transaction including verification values (e.g., dCVVs and other cryptograms to authenticate the portable device), a loyalty number for the consumer, etc. Finally, transaction data may comprise information received in order to determine issuer information (e.g., an issuer information request message) that may comprise a large amount of data related to a transaction or merely an issuer identifier. Typically, transaction data may comprise an issuer identifier for a transaction.

A “transaction” may include any interaction between two or more entities. For example, a transaction may be a payment transaction between a consumer and a merchant for goods or services or may be an authentication transaction between a presenter and an authenticating entity at a closed event (e.g., checking tickets at a sporting event).

A “payment transaction” may include any interaction between a buyer and a seller for a good or service. For example, a payment transaction may include a consumer initiating a transaction at a merchant website through a user computer or may include a consumer completing a purchase at a merchant's physical brick and mortar storefront.

A “verification device” may include any electronic device that may be used to verify the authenticity of a payment transaction. A verification device may be used by any entity within a transaction system. For example, a verification device may include an access device (e.g., a point-of-sale (POS) device), an ATM, a merchant computer, a payment processing network computer, an acquirer computer, or any other entity within a transaction processing system.

In some embodiments, the verification device may comprise a processor and a computer-readable medium comprising code that is configured to allow the processor to perform a method. The method may include receiving transaction data including an issuer identifier, determining issuer information associated with the issuer identifier, and providing the issuer information to a verifying entity. The verifying entity may then verify that a portable device matches the issuer information before a transaction is authorized. In some embodiments, the verification device may comprise a portable device reader that may receive transaction data by interacting with a portable device.

An “issuer identifier” may include any series of letters, numbers, characters, or any combination thereof which identify an issuer of an account. For example, the issuer identifier may include a bank identification number (BIN) that is associated with a bank that has issued a payment account that is associated with a portable device (e.g., credit card) being used by a consumer during a transaction. Typically, BINs are the first six digits of a primary account number (PAN) that may be encoded into a portable device (e.g., credit card) that identifies which bank has issued the payment account and allows a payment processor to determine where a transaction authorization request message should be routed.

According to embodiments of the invention, “issuer information” may include any information that is associated with an issuer. The issuer information may be stored in an issuer directory. The issuer directory may be distributed through a transaction processing system or may be located at a central location. The issuer directory may store information for issuers located throughout the world. For example, issuer information may include an issuer name, issuer country or other geographic identifier (e.g., country code, country name, etc.), issuer graphic (e.g., trademark or other character identifier that is associated with an issuer), portable device type or account type (e.g., a platinum card, silver card, etc.), account prefix range, account identifier length indicator, check-digit indicator information, and/or portable device graphic, image, or any other identifier for what the portable device may look like (e.g., an image of the front and/or back of a typical portable device issued by the issuer). Any other relevant information for identifying issuers may also be included in the issuer directory and used to identify and validate portable devices.

A “portable device” may include any device that may be used to conduct a transaction. For example, a portable device may be used to provide payment information to a merchant. A portable device may be in any suitable form. For example, suitable portable devices can be hand-held and compact so that they can fit into a consumer's wallet and/or pocket (e.g., pocket-sized). They may include smart cards, magnetic stripe cards, keychain devices, etc. Other examples of portable devices include cellular phones, smartphones, personal digital assistants (PDAs), pagers, payment cards, security cards, access cards, smart media, transponders, 2-D barcodes, an electronic or digital wallet, and the like. If the portable device is in the form of a debit, credit, or smartcard, the portable device may also optionally have features such as magnetic stripes. Such devices can operate in either a contact or contactless mode. The portable device may have account information encoded on the portable device that may include an issuer identifier and an account identifier. At initiation of a transaction, the account information including the issuer identifier may be passed to an access device and/or a verification device in order to process the transaction.

A “verifying entity” may include any entity involved in a transaction that may verify the authenticity of a presenter or portable device. A verifying entity may be a person or a computer (or any other device). For example, a verifying entity may be a merchant representative (e.g., a clerk working at a merchant) or could include an ATM (automated teller machine) or a computer associated with an ATM. A verifying entity may verify the issuer information associated with an issuer identifier through any suitable manner. For example, where the verifying entity is a human (e.g., a merchant representative), the verifying entity may verify the issuer information by visually comparing the received issuer information to a presented portable device. In other embodiments, the human verifying entity may ask the presenter questions about the account, may receive comparison information from the presenter during the transaction, or may perform any other method of obtaining information regarding the issuer associated with the presented portable device. Where the verifying entity is a computer, the verifying entity may compare the issuer information associated with the issuer identifier to a captured image of the portable device presented during the transaction (e.g., using image recognition software). Additionally, any other comparison method may be accomplished including having a presenter provide the supposed issuer information at the time of the transaction through a keyboard, voice recognition, or any other suitable method. After a verifying entity verifies the authenticity of the portable device, the verification device may generate an authorization request message for the transaction or otherwise process the transaction.

Additionally, in some embodiments, the verifying entity may be the verification device. For example, in some embodiments, a merchant computer may accept payment information and verify the portable device information using the same POS device or system. For instance, the verification device may capture a picture of the portable device when the portable device and the portable device reader interact such that the verification device captures the transaction data and a picture of the portable device at the same time. The verification device may then determine the issuer information by finding the issuer identifier received in the transaction data to an issuer directory including issuer information associated with issuer identifiers. Accordingly, the verifying entity may determine an issuer graphic, picture, or other portable device picture of what a portable device issued by a particular issuer should look like (i.e., portable device design) and can compare the captured portable device picture to the received issuer information. In other embodiments, the verification device may use optical recognition software or other technology to read the issuer name associated with a presented portable device and may compare that name to the issuer information to verify the authenticity of the portable device.

According to some embodiments, “offline verification” may include any verification of a presenter's portable device where issuer information is accessed at a local issuer directory. Accordingly, offline verification may not require a request for issuer information to be sent over a communications network. During offline verifications, a local or offline issuer directory may be used to determine issuer information associated with the issuer identifier. Accordingly, the offline issuer directory may be updated periodically in order to ensure the issuer information and issuer identifiers are up to date. Payment processors typically implement a weekly update of such issuer information and a file may be sent to the relevant entities involved in transaction processing in order to keep the transaction system up to date on issuer information and issuer identifiers. The issuer directories are updated for issuers throughout the world and may include issuer information including issuer name, country of origin, issuer graphic, native language, and any other relevant information that may be used to verify the accuracy of a portable device.

An “online verification” may include any verification of a presenter's portable device that uses an issuer directory that is accessed via a communications network. Typically, the verification may occur at a verification device separated geographically from an access device (e.g., POS device) or other transaction device that accepts the payment information from the portable device. Accordingly, online verification typically involves an issuer identification request message being sent to a verification device located away from the access device.

An “issuer identification request message” or “issuer information request message” may comprise any message, signal, or other communication packet that requests identification information associated with an issuer identifier. For example, in some embodiments, an issuer director may be maintained at a central entity such as a payment processing network or an acquirer. In such embodiments, the payment processing network or acquirer may comprise a verification device and issuer directory and may receive issuer identification request messages from merchants, point-of-sale devices, or any other entity involved in a transaction, requesting issuer information associated with an issuer identifier. The requesting entity may have pre-configured settings for the type of issuer information (e.g., only issuer name and country) that may be returned to them or the same issuer information may be returned for all requestors (e.g., all issuer information stored at the issuer directory).

An “issuer identification response message” or “issuer information response message” may comprise any message, signal, or other communication packet that provides issuer information to a requestor. The issuer identification response message may be customized for the requestor of the issuer information or may be uniform for all entities requesting issuer identification. For example, a payment processing network may have a merchant database that identifies the issuer information that is relevant to the merchant requesting the issuer information and may only provide issuer information that may be used by the merchant. The issuer identification response message may be returned to an access device associated with the merchant requesting the issuer information and the access device may forward the issuer information to the verifying entity after receiving the issuer identification response message.

An “authorization request message” may be an electronic message that is sent to a payment processing network and/or an issuer of a payment account to request authorization for a transaction. An authorization request message according to some embodiments may comply with ISO 8583, which is a standard for systems that exchange electronic transaction information associated with a payment made by a consumer using a portable device or payment account. The authorization request message may include an issuer account identifier that may be associated with a portable device or payment account. An authorization request message may also comprise additional data elements corresponding to identification information including, by way of example only: a service code, a CVV (card verification value), a dCVV (dynamic card verification value), an expiration date, etc. An authorization request message may also comprise any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant may call the toll-free authorization phone number. The authorization response message may also include an authorization code, which may be a code that an account issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

As used herein, an “issuer” may typically refer to a business entity (e.g., a bank or other financial institution) that maintains financial accounts for the user and often issues a portable device such as a credit or debit card to the user. As used herein, a “merchant” may typically refer to an entity that engages in transactions and can sell goods or services to the user or consumer. As used herein, an “acquirer” may typically refer to a business entity (e.g., a commercial bank or financial institution) that has a business relationship with a particular merchant or similar entity. Some entities can perform both issuer and acquirer functions.

### I. Exemplary Systems for Offline Issuer Identification and Verification

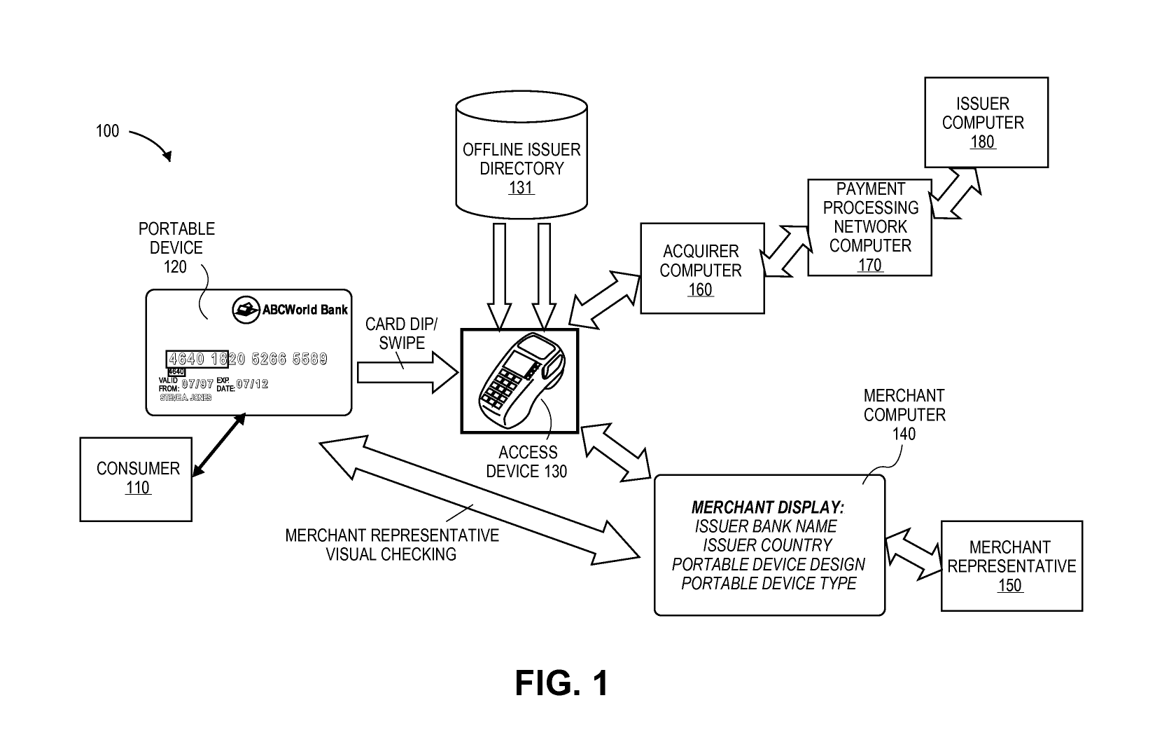

FIG. 1 illustrates a block diagram of an exemplary issuer identification and verification system 100 for offline issuer identification and verification of portable devices, according to an exemplary embodiment of the present invention. The offline issuer identification and verification system 100 may include a consumer 110, a portable device 120, an access device 130 (which is an example of a verification device) configured to interact or communicate with the portable device 120. The system 100 may also include an offline issuer directory 131 coupled to the access device 130, a merchant computer 140 communicatively coupled to the access device 130, and a merchant representative 150 operating or monitoring the merchant computer 140. The system may further include an acquirer computer 160, a payment processing network computer 170, and an issuer computer 180. Each of these components may be communicatively coupled together. Embodiments of the issuer identification and verification system 100 may comprise fewer than or all of these entities depending on its implementation. For example, in some embodiments, a merchant computer 140 and an access device 130 may be a single device (e.g., a tablet device that is used by a merchant as an access device and merchant computer 140).

A consumer 110 may be any individual buyer, representative of a corporate entity, or any other person that is presenting a portable device 120 (e.g., credit or debit card) during a transaction with a merchant representative 150 or other seller. The consumer 110 may have an account issued by an issuing bank and may be provided a portable device 120 with financial or other account information encoded onto the portable device 120 such that the consumer 110 may use the portable device 120 to initiate and complete a transaction using their account at the issuing bank. Non-financial transactions may also be completed using a portable device 120 provided by an issuer but in the interest of brevity, the system of FIG. 1 focuses on a payment transaction.

A portable device 120 may interact with an access device 130 (e.g., a point-of-sale (POS) device) in order to initiate the processing of a transaction. The portable device 120 may be issued by an issuer and the account information encoded (or otherwise contained) on the portable device 120 may be accessible to the issuer computer 180. The account information may be encoded or contained on the portable device 120 through any suitable method. Further, a portable device 120 may include any suitable element, component, or mechanism for initiating a transaction. For example, the portable device 120 may have a magnetic stripe, mobile wallet application, near-field communication (NFC) element, or any other components to transfer information to an access device 130.

An access device 130 may comprise or may be coupled to an offline issuer directory 131 or other issuer information database. The access device 130 may be an access point to a transaction processing system that comprises a merchant computer 140, an acquirer computer 160, a payment processing network computer 170, and an issuer computer 180. In some embodiments, where the access device 130 is used to determine issuer information associated with a portable device 120 and provide the issuer information to a merchant representative 150 or merchant computer 140, the access device 130 may also be referred to as a verification device. The verification device may comprise a processor and a computer-readable medium comprising code that is configured to allow the processor to perform a method. The method may include receiving transaction data including an issuer identifier, determining issuer information associated with the issuer identifier, and providing the issuer information to a verifying entity. In other embodiments, any other entity within the transaction system 100 may be the verification device.

An offline issuer directory 131 may comprise issuer information associated with issuer identifiers. The offline issuer directory 131 may be stored in the memory of the access device 130 (i.e., verification device) such that the access device 130 does not have to request issuer information from a third party or other entity after receiving transaction data. Instead, the access device 130 may determine an issuer identifier associated with transaction data, may search the offline issuer database for issuer information associated with the issuer identifier, and may provide the issuer information to a verifying entity so that a portable device 120 may be validated and a transaction may be completed. The offline issuer directory 131 may include a data table comprising issuer information sorted by issuer identifier. For example, for an issuer identifier of 123456 the issuer directory may have an issuer name (e.g., XYZ Bank), a country of origin (e.g., the United States), an issuer graphic (e.g., a trademark registered to XYZ Bank—the target graphic shown in FIG. 5), a portable device language (e.g., English), a sample image of the typical portable device 120 issued by the bank (e.g., a graphic of the front and back of generic portable devices 120 issued by XYZ Bank), and any other relevant information that a verifying entity (e.g., merchant representative 150, ATM device, etc.) may find useful to determine whether a portable device 120 is authentic and associated with the represented issuer.

A merchant computer 140 can include any computer that is capable of communicating with an access device 130, an acquirer computer, displaying issuer information to a merchant representative 150, and receiving confirmation or other inputs from a merchant representative 150 regarding the verification of a portable device 120 as being authentic or suspected to be counterfeit. For example, a merchant computer 140 may comprise an external communication interface (e.g., for communicating with an access device 130 and an acquirer computer 160), system memory comprising one or modules to generate and utilize electronic messages, and a data processor (for facilitating a financial transaction and the exchange of electronic messages). The external communication interface of the merchant computer 140 may be coupled to an access device 130 (such that information may be received by the access device 130 and communicated to the merchant computer 140) or, in some embodiments, the access device 130 may comprise a component of the merchant computer 140.

An acquirer computer 160 can be a computer associated with any bank or other financial institution that provides and maintains a financial account for the merchant. An acquirer computer 160 may include a server computer that is configured to receive an authorization request message from a merchant computer 140 or access device 130 and forward the authorization request message to the relevant payment processing network for processing. Accordingly, the acquirer computer 160 may comprise an external communication interface (e.g., for communicating with a merchant computer 140 (or access device 130) and a payment processing network computer 170), system memory comprising one or modules to generate and utilize electronic messages, and a data processor (for facilitating a financial transaction and the exchange of electronic messages).

A server computer can be a powerful computer or a cluster of computers. For example, the server computer can be a large mainframe, a minicomputer cluster, or a group of servers functioning as a unit. In one example, the server computer may be a database server coupled to a Web server.

A payment processing network computer 170 may be disposed between the acquirer computer 160 and the issuer computer 180 in the transaction system. Furthermore, the merchant computer 140, the acquirer computer 160, the payment processing network computer 170, and the issuer computer 180 may all be in operative communication with each other (i.e., although not depicted in FIG. 1, one or more communication channels may exist between each of the entities, whether or not these channels are used in conducting a financial transaction).

The payment processing network may include data processing subsystems, networks, and operations used to support and deliver authorization services, exception file services, and clearing and settlement services. For example, the payment processing network may comprise a server computer 170 and databases of information. An exemplary payment processing network may include, for example, VisaNet™. Payment processing networks such as VisaNet™ are able to process credit card transactions, debit card transactions, and other types of commercial transactions. VisaNet™ , in particular, includes a VIP system (Visa Integrated Payments system) which processes authorization requests and a Base II system which performs clearing and settlement services. The payment processing network computer 170 may use any suitable wired or wireless network, including the Internet.

An issuer computer 180 can be a computer of any financial institution that issues and maintains a financial account for a consumer 110. The issuer computer 180 may be coupled to a payment processing network computer 170 and may include a server computer configured to receive authorization request messages, determine whether a transaction should be authorized or declined, and return an authorization response message including a transaction decision. Accordingly, an issuer computer 180 may comprise an external communication interface (e.g., for communicating with a payment processing network computer 170), system memory comprising one or modules to generate and utilize electronic messages, and a data processor (for facilitating a financial transaction and the exchange of electronic messages).

A typical credit card transaction flow using a portable device 120 at an access device 130 (e.g., POS location) can be described as follows. (Note that embodiments of the invention are not limited to credit card transactions, but may also include other types of payment transactions including prepaid and debit transactions). A consumer 110 may present their portable device 120 to an access device 130 to pay for an item or service. The portable device 120 and the access device 130 interact such that information from the portable device (e.g., primary account number (PAN), verification value(s), expiration date, etc.) is received by the access device 130 (e.g., via contact or contactless interface). The merchant computer 140 may then receive this information from the access device 130 via the external communication interface. The merchant computer 140 may then generate an authorization request message that includes the information received from the access device 130 (i.e., information corresponding to the portable device 120) along with additional transaction information (e.g., a transaction amount, merchant specific information, etc.) and electronically transmit this information to an acquirer computer 160. The acquirer typically represents, and vouches for, the merchant in financial transactions (e.g., credit card transactions). The acquirer computer 160 may then receive, process, and forward the authorization request message to a payment processing network computer 170 for authorization.

In general, prior to the occurrence of a credit-card transaction, the payment processing network has an established protocol with each issuer regarding how the issuer's transactions are to be authorized. In some cases, such as when the transaction amount is below a threshold value, the payment processing network computer 170 may be configured to authorize the transaction based on information that it has about the consumer's account without generating and transmitting an authorization request message to the issuer computer 180. In other cases, such as when the transaction amount is above a threshold value, the payment processing network computer 170 may receive the authorization request message via its external communication interface, determine the issuer associated with the portable device 120, and forward the authorization request message for the transaction to the issuer computer 180 for verification and authorization. As part of the authorization process, the payment processing network computer 170 or the issuer computer 180 may analyze a verification value or other datum provided by the portable device 120. The verification value may be stored at the issuer or the payment processing network (e.g., in one or more of databases). Once the transaction is authorized, the issuer computer 180 may generate an authorization response message (that may include an authorization code indicating the transaction is approved or declined) and transmit this electronic message via its external communication interface to payment processing network computer 170. The payment processing network computer 170 may then forward the authorization response message via a communication channel to the acquirer computer 160, which in turn may then transmit the electronic message to comprising the authorization indication to the merchant computer 140.

In the credit card industry, for example, the authorization indication typically takes the form of an authorization code, which is five or six alphanumeric characters, by convention. It serves as proof to the merchant and the consumer 110 that the issuing bank or payment processing network has authorized the transaction, and may be used by the merchant or the consumer 110 as proof of authorization if the issuing bank later disputes the transaction, such as during settlement.

At the end of the day (or some other periodic time), a normal clearing and settlement process can be conducted by the payment processing network computer 170. A clearing process is a process of exchanging financial details between an acquirer computer 160 and an issuer computer 180 to facilitate posting to a consumer's account and reconciliation of the consumer's settlement position. Clearing and settlement can occur simultaneously. Typically, the merchant computer 140 sends the clearance information to the acquirer computer 160 at the end of the day, and the acquirer computer 160 and issuer computer 180 can subsequently facilitate the clearing and settlement process.

### II. Exemplary Methods for Offline Issuer Identification and Verification

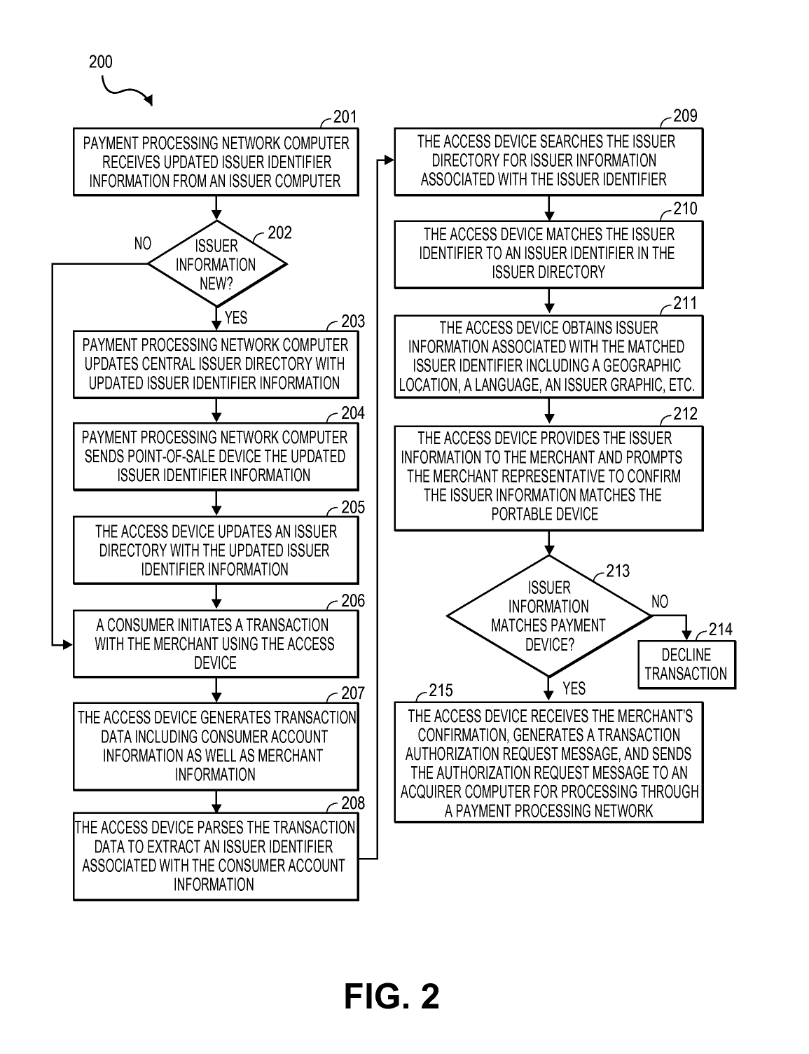

FIG. 2 shows an exemplary process for determining and verifying the issuer of encoded account data in a portable device 120 being presented during a transaction, according to an exemplary embodiment of the present invention. The first steps of the method relate to updating the offline issuer directory 131 when a payment processing network computer 170 receives updated issuer identifier and issuer information. After updating the offline issuer directory, the method includes identifying and verifying an issuer associated with a portable device 120 presented during a transaction.

At step 201, the payment processing network computer 170 receives updated issuer identifier information from an issuer computer 180. Issuers may update their issuer identifiers when they produce new payment products, issue new card types, when a new payment processor is launched, or at any other suitable time.

At step 202, the payment processing network computer 170 may determine whether the issuer information is new and whether the issuer directory needs to be updated. If so, the payment processing network computer 170 may initiate a process for updating the local issuer directories 131 of access devices 130, acquirer computers 160, issuer computers 180, and any other entities throughout the transaction eco-system. If the payment processing network computer 170 determines that the issuer information is not new or the changes are so minor that updates are not necessary, the offline issuer directory updating process shown in steps 202-204 may be skipped. The importance of the updates may depend on the type of information that is updated and its importance to the verification and identifier process. For example, if an issuer identifier is changed, an update process is necessary to ensure transactions may be properly routed to the issuer identifier. However, if an issuer merely changes their address or phone number, the update may not affect the verification and identification process. Accordingly, the payment processing network computer 170 may determine that an update is not necessary at this time and may merely update the issuer directory 131 when the next update is due or when a more instrumental change is made.

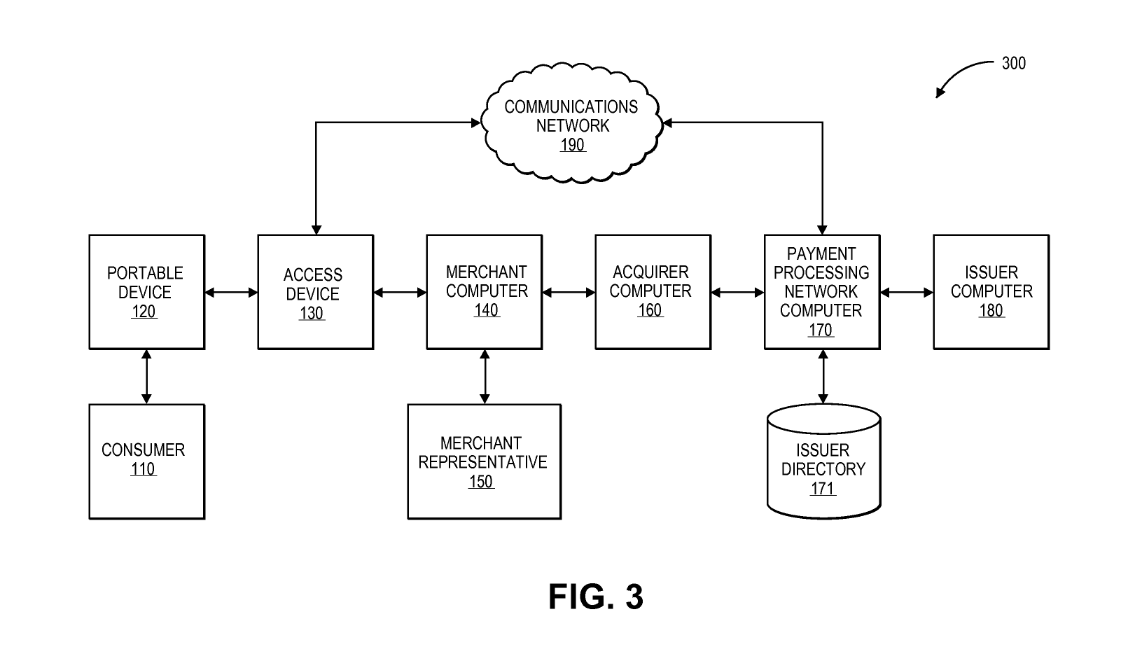

At step 203, the payment processing network computer 170 updates the central issuer directory 171 (shown in FIG. 3) with updated issuer identification information. In some embodiments, the payment processing network computer 170 may be coupled to a central issuer directory that the payment processing network computer 170 uses to update the offline issuer directories 131 distributed across the transaction system. The central issuer directory 171 may also include an issuer directory file that may be exported to access devices 130 or access device owners periodically to ensure the access devices 130 can correctly identify and route transactions to the correct acquirers computers 160, payment processing network computers 170, and issuer computers 180.

At step 204, the payment processing network computer 170 sends the access device (e.g., POS device) the updated issuer identification information. The update process may occur through any suitable method. For example, the payment processing network may “push” an updated copy of the central issuer directory to access devices (e.g., POS devices) that are connected to the transaction system, the POS devices may periodically (e.g., once a week) request updates to the offline issuer directory 131, or the updated central issuer directory file may be downloaded onto the POS device 130 before each transaction. Any suitable method for storing the offline issuer directory 131 onto the access device 130 or coupling the offline issuer directory 131 to the access device 130 such that the access device 130 does not need to request issuer information over a communications network may be implemented.

At step 205, a consumer 110 presents a portable device 120 (e.g., a credit or debit card, smartphone, etc.) during a transaction at a merchant. For example, the portable device 120 may be presented through swiping the portable device 120 through a POS device (or any other type of access device 130) to initiate a transaction. The transaction data may be stored on a magnetic stripe on a portable device 120 or through any other suitable manner (e.g., chip card, NFC communications transmission from a secure element, etc.). During the swiping of the portable device 120, the merchant representative 150 may have access to the portable device 120 (e.g., card) so that it is easily recognizable what issuer is displayed on the face (or elsewhere) of the card.

At step 206, the access device 130 generates transaction data including both consumer account information as well as merchant information. For example, the consumer 110 may swipe the portable device 120 comprising account information (including both issuer identifier and account identifier) and the access device 130 may receive product information, transaction amount, and any other relevant transaction data for processing the transaction from a merchant computer 140, from a merchant representative 150 entering the information into the access device 130, or through any other suitable manner. Accordingly, the access device 130 may receive the encoded account information from the portable device 120 and may further receive merchant information to make up the complete transaction data for the transaction.

At step 208, the access device 130 parses the transaction data to extract an issuer identifier associated with the consumer account information. The access device 130 may separate the issuer identifier through any suitable method including parsing of the transaction information, parsing of the account information received from the portable device 120, or parsing of an authorization request message that is received or generated by the access device 130.

At step 209, the access device 130 searches the issuer directory 131 for issuer information associated with the issuer identifier. For example, if the issuer identifier encoded on a portable device 120 is 123456, the access device 130 may access the offline issuer directory 131 of issuer information and search for an issuer identifier that matches the issuer identifier 123456 of the transaction data.

At step 210, the access device 130 matches the issuer identifier (e.g., 123456) of the transaction data to an issuer identifier (e.g., 123456) in the offline issuer directory 131. If the access device 130 finds the issuer identifier (e.g., 123456) directory entry that matches the issuer identifier 123456 of the transaction data, the access device 130 may request the issuer information associated with the issuer identifier entry.

At step 211, the access device 130 obtains issuer information associated with the matched issuer identifier. For example, the issuer directory 131 may comprise any number of data fields including issuer name, issuer country of origin, issuer home language, as well as any other relevant issuer information (e.g., phone number, zip code, etc.).

At step 212, the issuer identification and verification system may then provide the corresponding issuer information to the merchant representative 150 (e.g., displaying “XYZ Bank,” “XYZ Bank in the United States,” or “United States of America,” etc.). Depending on the configuration of the transaction system, the issuer information may be provided to the merchant representative 150 in a number of different manners. For example, the access device 130 may send the issuer information to a merchant computer 140 coupled to the access device 130 and the merchant computer 140 may display the issuer information for the merchant representative's 150 verification of a portable device 120. Alternatively, where the merchant representative 150 has access to the access device 130 or where the access device 130 itself is integrated into the merchant computer 140, the access device 130 may display the issuer information for the merchant representative's 150 verification. Alternatively, the access device 130 may send a text message, phone call, or other message to a merchant device 140 such as a merchant representative's cell phone, beeper, pager, etc. Accordingly, the issuer information may be provided for display in any suitable manner (e.g., in a phone call, text message, video clip, etc.).

At step 213, a verifying entity (e.g., a merchant representative 150) may be prompted to confirm or verify that the received or displayed issuer information (e.g., the issuer name and/or the issuer country) matches the portable device 120 being presented by the consumer 110. The verifying entity may confirm or verify the issuer information with the portable device 120 through any suitable method. For example, the verifying entity may visually inspect the portable device 120 (as shown in FIG. 6 and described above). Alternatively, where the verifying entity is a computer, verification device, or some other automated verification process, an image of the portable device 120 may be taken and compared to the received issuer information to determine whether they match or are close enough to provide a high probability of matching or being valid. For example, optical character recognition (OCR) or other similar technology may be used to verify the portable device.

Accordingly, where a verifying entity (e.g., merchant representative 150) determines that the issuer information received from the access device (e.g., verification device) does not match the portable device 120 being presented for a transaction, the verifying entity may decline the transaction or otherwise halt and/or suspend the transaction until further identification can occur. For example, the merchant representative 150 may enter a decline button or otherwise indicate to the system that the issuer information does not match the presented portable device 120. FIG. 6 illustrates an exemplary interface 604 for approving or declining the transaction.

Accordingly, at step 214, the decline message or other input by the merchant representative 150 that the issuer information does not match the portable device 120 may be sent to the access device 130 and the access device 130 may decline the transaction before an authorization request message may be generated. Accordingly, because the issuer identification and verification system allows a merchant to determine a fraudulent or counterfeited portable device 120 prior to the initiation of a transaction, embodiments provide the additional advantages of limit network traffic over payment processing infrastructure and lead to lower throughput and more efficient use of network resources. Additionally, embodiments result in fewer charge-backs due to fraudulent transactions and further limit the network communications necessary between entities settling accounts.

Alternatively, however, if at step 213, the merchant computer 140 displays that the issuer identifier encoded on the portable device 120 is associated with the local bank (e.g., “ABCWorld bank”), the merchant representative 150 may provide confirmation that the portable device 120 and the encoded account identifier match and thus, the portable device 120 is likely not counterfeit. Accordingly, the merchant representative 150 may enter a verification command into the merchant computer 140, the merchant computer 140 may send a response message to the access device 130, or the merchant computer 140 may confirm that the transaction is verified through any other suitable manner.

Furthermore, the verification or confirmation of the verifying entity may occur through any suitable manner. For example, the merchant representative 150 may be prompted to enter the name or country of the issuer computer 180 displayed on the portable device 120 being presented before a transaction may be initiated such that the merchant computer 140 or access device 130 automatically halts the transaction if the issuer name or country does not match the received issuer information. Alternatively, the merchant representative 150 may be asked whether the portable device 120 body matches the issuer information received from the issuer identification and verification system in a message such as, for example, “Does the card presented say it is a ABCWorld Bank credit card?” or “Please confirm that the presented card shows an issuer located in United States of America.” In this manner the merchant representative 150 may be reminded to look at the portable device 120 being presented and in some embodiments, fraudulent transactions could be halted before being initiated. Additionally, the merchant representative 150 may merely be conscious of the card being displayed and receive a text message or display on the merchant computer 140 during a transaction saying, for example, “The card being presented is for an account at a ABCWorld Bank originating in the United States of America,” or any other suitable notification of the issuer information associated with the encoded issuer identifier.

At step 215, the access device 130 receives the merchant's confirmation, generates a transaction authorization request message, and sends the authorization request message to an acquirer computer 160 for processing through a payment processing network. Accordingly, once the merchant representative 150 has confirmed or verified the portable device 120, the transaction may be processed as a typical transaction.

Although the process described in reference to FIG. 3 focuses on a payment transaction, embodiments of the invention should not be limited to such transactions. For example, embodiments of the present invention could be used with authentication transactions, entry into restricted events, or any other suitable transactions.

Furthermore, alternative embodiments may include a merchant computer 140 that is configured to interact with the access device 130 described above and the merchant representative 150 may receive the issuer information on their merchant computer 140 instead of through the access device 130. Additionally, other embodiments may comprise a single access device 130 and merchant computer 140 that is incorporated into a single verification device. Furthermore, the merchant verification may occur by an automated computer using optical recognition of portable devices 120 where a merchant clerk is not present (e.g., ATM transactions, an automated merchant clerk device, etc.).

Finally, other devices in the transaction eco-system may perform the steps that are described as being implemented by the access device 130 including receiving transaction data in the form of a transaction authorization request message, parsing an issuer identifier from the authorization request message, searching a local or offline issuer directory, and providing issuer information in response either before further processing the transaction or as part of the transaction processing method. Accordingly, the acquirer computer 160, payment processing network computer 170, or issuer computer 180 may perform the steps of a verification device described above in relation to the access device 130. These alternative embodiments may be implemented such that the identification and verification process is implemented using an online issuer directory or may be performed using an offline issuer directory.

### III. Exemplary System for Online Issuer Identification and Verification

In some embodiments, an online issuer identification and verification process may be possible using a central issuer directory 171 that is managed by an acquirer computer 160, payment processing network computer 170, or other third party entity (not shown) in a transaction processing system. For example, FIG. 3 illustrates a block diagram of an exemplary issuer identification and verification system for online issuer identification and verification of transactions, according to an exemplary embodiment of the present invention.

As can be seen in FIG. 3, the online issuer identification and verification system 300 comprises the same entities as the offline identification and verification system 100 except that the issuer directory 171 is located at a central entity (e.g., a payment processing network in the embodiment shown in FIG. 3) instead of at an access device 130 and the access device 130 or merchant computer 140 may send an issuer identification request message to the verification device (payment processing network computer 170 in the embodiment shown in FIG. 3) in order to determine the issuer information associated with an encoded issuer identifier.

Furthermore, the online issuer identification and verification system may comprise a communications network 190 connection between an access device 130 and the verification device (in this case the payment processing network computer 170) such that an issuer information request message may be sent to the payment processing network computer 170 before a transaction authorization request message has been generated by the access device 130 or the merchant computer 140.

A central issuer directory 171 (which may be called an online issuer directory) may be the same database as has been described above but may be located and managed at an acquirer computer 160, payment processing network computer 170, or issuer computer 180, or may located at a third party remotely connected to the merchant access device 130 through a real time issuer directory access connection (e.g., communications network 190). The issuer directory 171 may be connected through any communication medium including either a closed or proprietary transaction processing communication network, open communication network (e.g., the internet, a telecommunications network, etc.), short range communications network (e.g., Bluetooth, NFC, etc.), or any other suitable communications network.

### IV. Exemplary Methods for Online Issuer Identification and Verification

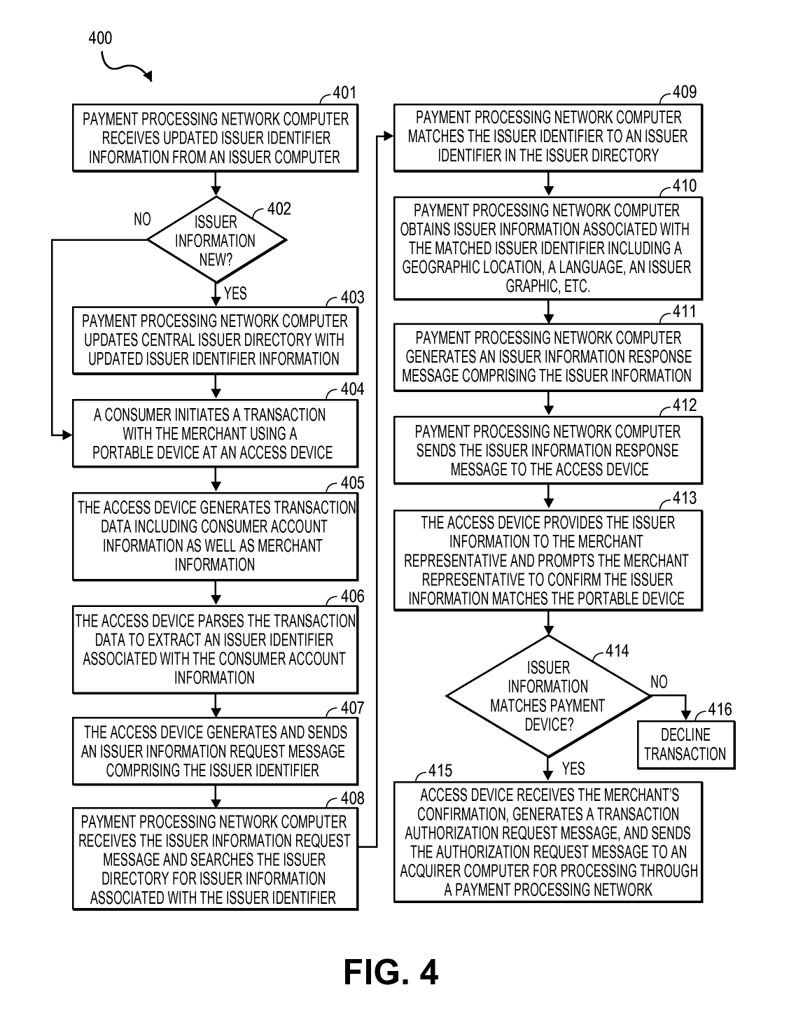

FIG. 4 illustrates an exemplary flow chart of a method for online identification and verification of a portable device 120, according to an exemplary embodiment of the present invention. As can be seen in FIG. 4, the online issuer identification and verification system may operate similarly to the offline issuer identification and verification system but may incorporate issuer identification request messages and issuer identification response messages that are sent to and from the verification device during a transaction.

At steps 401-403, the payment processing network computer 170 receives updated issuer identification information from an issuer computer 180 and updates the central issuer directory as described in relation to the flowchart of FIG. 2. One of the benefits of the online issuer directory is that maintenance and updating issuer directories is simplified as a single entity may be responsible for updating a single issuer directory instead of distributing and updating issuer directories to access devices 130 or merchant computers 140 throughout the transaction eco-system.

At step 404-406, just as in the offline verification system, a consumer initiates a transaction with the merchant using a portable device 120 (step 404), the access device 130 generates transaction data including consumer account information as well as merchant information (step 405), and the access device 130 parses the transaction data to extract an issuer identifier associated with the consumer account information (step 406).

However, at step 407, in an online identification and verification method, the access device 130 generates and sends an issuer identification request message comprising the issuer identifier to a verification device (e.g., payment processing network computer 170) that is configured to identify issuer information associated with issuer identifiers and return the issuer information to the requesting entity (e.g., access device 130).

At steps 408-410, the payment processing network computer 170 may search the central issuer directory (step 408), match the issuer identifier to an issuer directory database entry (step 409), and obtain the issuer information (step 410) similarly to the process described above regarding the access device 130 in relation to FIG. 3.

However, at step 411, the payment processing network computer 170 generates an issuer identification response message comprising the issuer information associated with the issuer identifier. The issuer identification response message may comprise any relevant information for the verifying entity including

At step 412, the payment processing network computer 170 sends the issuer information response message to the access device 130. The access device 130 may thereafter complete the transaction much as described in regards to the offline verification process described in relation to FIG. 3. Accordingly, steps 413-416 are described in relation to steps 212-215 above.

Alternatively, in some embodiments, the steps described above regarding the online issuer identification and verification process may be performed during the processing of an authorization request message and the issuer information may be returned to an access device 130 or merchant computer 140 along with (or as part of) an authorization response message. Accordingly, the merchant representative 150 or other verifying entity may then be provided with the opportunity to cancel the transaction before providing the product or service that is the purpose of the transaction. Accordingly, issuer information may be provided to a merchant representative 150, verification device, or other verifying entity in any suitable manner.

### V. Exemplary Computer Systems

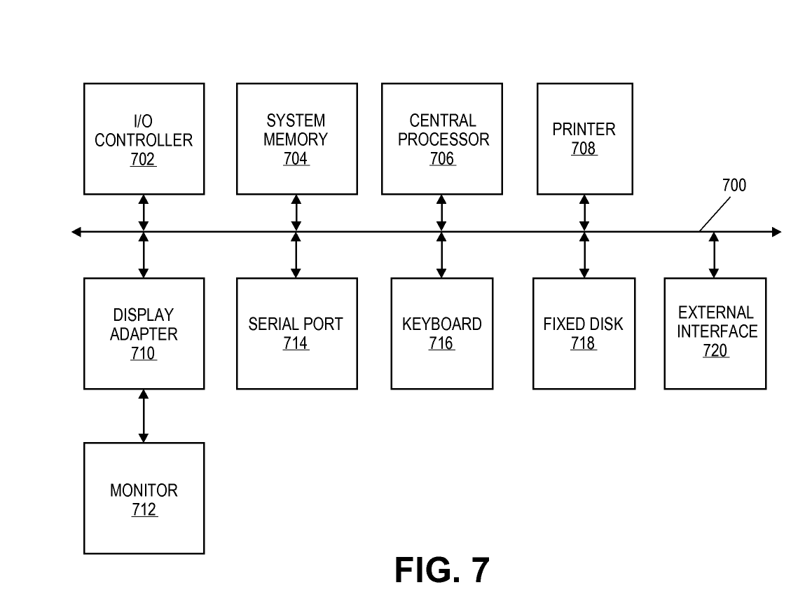

The various participants and elements in FIGS. 1 and 3 may operate one or more computer apparatuses (e.g., a server computer) to facilitate the functions described herein. Any of the elements in FIGS. 1 and 3 may use any suitable number of subsystems to facilitate the functions described herein. Examples of such subsystems or components are shown in FIG. 7. The subsystems such as a printer 708, keyboard 716, fixed disk 718 (or other memory comprising computer readable media), monitor 712, which is coupled to a display adapter 710, and others are shown. Peripherals and input/output (I/O) devices, which couple to I/O controller 702, can be connected to the computer system by any number of means known in the art, such as serial port 714. For example, serial port 714 or external interface 720 can be used to connect the computer apparatus to a wide area network such as the Internet, a mouse input device, or a scanner. The interconnection via system bus allows the central processor 706 to communicate with each subsystem and to control the execution of instructions from system memory 704 or the fixed disk 718, as well as the exchange of information between subsystems.

Specific details regarding some of the above-described aspects are provided below. The specific details of the specific aspects may be combined in any suitable manner without departing from the spirit and scope of embodiments of the invention.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary.

What is claimed is:

1. A verification device comprising:
a processor; and
a computer-readable medium coupled to the processor, the computer-readable medium comprising code executable by the processor for performing a method, the method comprising:
receiving transaction data including an issuer identifier;
determining issuer information associated with the issuer identifier; and
providing the issuer information to a verifying entity, wherein the verifying entity verifies that a portable device matches the issuer information before a transaction is authorized.

2. The verification device of claim 1, wherein the issuer identifier is a bank identification number (BIN), wherein the issuer information includes issuer country or issuer name, and wherein the verifying entity is a human.

3. The verification device of claim 2, wherein the issuer information further comprises issuer graphic, portable device type, or portable device graphic.

4. The verification device of claim 2, wherein the human verifies the issuer information by comparing the issuer information to the portable device.

5. The verification device of claim 3, wherein the verifying entity verifies the issuer information by the verification device capturing an image of the portable device and comparing the image of the portable device to the issuer graphic.

6. The verification device of claim 2, wherein the transaction is a payment transaction and wherein the method further comprises generating an authorization request message for the transaction after the verifying entity verifies the portable device.

7. The verification device of claim 2, further comprising a portable device reader coupled to the processor, wherein the transaction data is received from a portable device using the portable device reader.

8. The verification device of claim 2, wherein receiving transaction data further comprises receiving an issuer identification request message including an issuer identifier from an access device, and wherein providing the issuer information to the verifying entity further comprises sending an issuer identification response message including the issuer information to the access device, wherein the access device forwards the issuer information to the verifying entity.

9. The verification device of claim 1, wherein the verifying entity is a merchant computer.

10. The verification device of claim 2, wherein the verifying entity is the verification device.

11. A method comprising:
receiving, by a processor, transaction data including an issuer identifier;
determining, by the processor, issuer information associated with the issuer identifier; and
providing, by the processor, the issuer information to a verifying entity, wherein the verifying entity verifies that a portable device matches the issuer information before a transaction is authorized.

12. The method of claim 11, wherein the issuer identifier is a bank identification number (BIN), wherein the issuer information includes issuer country or issuer name, and wherein the verifying entity is a human.

13. The method of claim 12, wherein the issuer information further comprises issuer graphic, portable device type, or portable device graphic.

14. The method of claim 12, wherein the human verifies the issuer information by comparing the issuer information to the portable device.

15. The method of claim 13, wherein the verifying entity verifies the issuer information by the verification device capturing an image of the portable device and comparing the image of the portable device to the issuer graphic.

16. The method of claim 12, wherein the transaction is a payment transaction and wherein the method further comprises generating an authorization request message for the transaction after the verifying entity verifies the portable device.

17. The method of claim 12, further comprising a portable device reader coupled to the processor, wherein the transaction data is received from a portable device using the portable device reader.

18. The method of claim 12, wherein receiving transaction data further comprises receiving an issuer identification request message including an issuer identifier from an access device, and wherein providing the issuer information to the verifying entity further comprises sending an issuer identification response message including the issuer information to the access device, wherein the access device forwards the issuer information to the verifying entity.

19. The method of claim 11, wherein the verifying entity is a merchant computer.

20. The method of claim 12, wherein the verifying entity is the verification device.
